(19) United States
(12) Patent Application Publication
(10) Pub. No.: US 2024/0414276 A1
(43) Pub. Date: Dec. 12, 2024

(54) IMAGE FORMING APPARATUS, IMAGE TRANSMISSION METHOD, AND NON-TRANSITORY COMPUTER-READABLE RECORDING MEDIUM

(71) Applicant: Konica Minolta, Inc., Tokyo (JP)

(72) Inventor: Hiroyuki SUZUKI, Toyokawa-shi (JP)

(73) Assignee: KONICA MINOLTA, INC., Tokyo (JP)

(21) Appl. No.: 18/675,231

(22) Filed: May 28, 2024

(30) Foreign Application Priority Data
Jun. 6, 2023 (JP) 2023-093062

(51) Int. Cl. H04N 1/00; G06V 30/413

(52) U.S. Cl. CPC H04N 1/00875; G06V 30/413; H04N 1/00328; H04N 1/00846

(57) ABSTRACT

An image forming apparatus includes an image reading section configured to read an image formed on a sheet, an area determination section configured to determine an image area included in the image read by the image reading section, a replacement section configured to replace the image area with a test pattern image predetermined according to the image area, and an image forming section configured to form and output an image obtained by replacing the image area with the test pattern image.

### CROSS REFERENCE TO RELATED APPLICATIONS

This application is based on Japanese Patent Application No. 2023-093062 filed on Jun. 6, 2023, the contents of which are incorporated herein by reference.

### BACKGROUND OF THE INVENTION

### Technical Field

The present invention relates to an image forming apparatus, an image transmission method, and a non-transitory computer-readable recording medium.

### Description of the Related Art

An image forming apparatus such as an MFP (Multifunction Peripherals) executes various jobs such as a scan job, a print job, and a copy job. Execution of such jobs in the image forming apparatus may result in image abnormality. For example, in the case of a scan job, image abnormality such as moire or streaky image contamination may occur in image data generated by reading an image of a document (sheet). Furthermore, in the case of a print job, image abnormality such as moire or streaky image dirt, color misregistration, or color bleeding may occur in an image formed on a sheet such as a printing sheet.

On the other hand, in recent years, a service person staying at a service base has a call or the like with a user of the image forming apparatus via a telephone line, to specify the cause of the trouble occurring in the image forming apparatus. Based on the specified cause, the service person guides the user to replace or clean a component, or sends a service person for maintenance work. For example, when an image abnormality occurs in a printed matter in a copy job or a print job, a user transmits image data read by scanning the printed matter to a service person at a service base, and requests the service person to investigate the cause of the trouble. However, confidential information may be included in the printed matter in which image abnormality has occurred. In a case where confidential information is included in the printed matter, when image data read by scanning the printed matter is transmitted to a service base without being processed, the confidential information may be leaked to the outside.

Therefore, when confidential information is included in the printed matter, the image forming apparatus adopts a configuration in which the image data of the printed matter in which the image abnormality has occurred is not transmitted to the service base as it is. For example, a conventional image forming apparatus transmits, to a service base, image date of a printed matter on which a test pattern different from that on the printed matter having the image abnormality is printed (e.g., Patent Literature 1: JP2006-166058A).

However, since the conventional image forming apparatus transmits the image of the printed matter on which the test pattern different from the printed matter including the confidential information is printed to the service base, the image abnormality may not be reproduced in the printed matter on which the test pattern is printed. In a case where the image abnormality is not reproduced in the printed matter on which the test pattern is printed, the service person at the service base cannot specify the cause of the trouble even by analyzing the image data received from the image forming apparatus.

For example, a moire image abnormality is an image abnormality that can occur in a halftone dot area included in an image. Therefore, in a case where the image abnormality occurring in the printed matter is moire, even if the halftone dot pattern is replaced with another pattern such as a line drawing different from the halftone dot pattern, the moire occurring in the printed matter cannot be reproduced.

Furthermore, an image abnormality that occurs in a printed product may depend on a document layout. In this case, even if the entire document is simply replaced with the test pattern without considering the document layout, the image abnormality cannot be appropriately reproduced.

### SUMMARY OF THE INVENTION

The present invention is directed to provide an image forming apparatus, an image transmission method, and a non-transitory computer-readable recording medium that solve the above-described problem. That is, the present invention is directed to generate image data in which an image abnormality is reproduced when the image abnormality occurs in an image including confidential information.

In order to achieve the above purposes, firstly, the present invention is directed to an image forming apparatus.

In one aspect of the first invention, the image forming apparatus includes an image reading section that reads an image formed on a sheet, an area determination section that determines an image area included in the image read by the image reading section, a replacement section that replaces the image area with a test pattern image predetermined according to the image area, and an image forming section that forms and outputs an image in which the image area is replaced with the test pattern image.

Secondly, the present invention is directed to an image transmission method in an image forming apparatus including an image reading section for reading an image formed on a sheet and an image forming section for forming and outputting an image.

In one aspect of the second invention, the image transmission method includes: causing an image reading section to read an image of a sheet on which an image abnormality has occurred; determining an image area included in the image read by the image reading section; replacing the image area with a test pattern image predetermined according to the image area; causing the image forming section to form an image in which the image area has been replaced with the test pattern image; causing the image reading section to read an image output from the image forming section to generate image data; and transmitting the image data to an external apparatus.

Thirdly, the present invention is directed to a non-transitory computer-readable recording medium storing a program to be executed in an image forming apparatus including an image reading section reading an image formed on a sheet and an image forming section forming and outputting an image.

In one aspect of the third invention, a program recorded on a recording medium causes an image forming apparatus to execute: causing an image reading section to read an image of a sheet in which an image abnormality has occurred; determining an image area included in the image read by the image reading section; replacing the image area with a test pattern image predetermined in accordance with the image area; causing an image forming section to form an image in which the image area is replaced with the test pattern image; causing the image reading section to read the image output from the image forming section to generate image data; and transmitting the image data to an external apparatus.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an example of the configuration of a network system including image forming apparatuses;

FIG. 2 is a block diagram illustrating an example of a hardware configuration and a functional configuration of the image forming apparatus;

FIG. 3A and FIG. 3B illustrate an example in which image abnormality occurs when a copy job is executed in the image forming apparatus;

FIG. 4 is a block diagram illustrating a detailed functional configuration of an image abnormality processing section;

FIG. 5 illustrates a determination result by an area determination section;

FIG. 6 illustrates a plurality of test pattern images for a halftone dot area;

FIG. 7 illustrates a plurality of test pattern images for a character area;

FIG. 8 illustrates a plurality of test pattern images for a photograph area;

FIG. 9 illustrates an image in which each of a halftone dot area, a character area, and a photograph area is replaced with a test pattern image;

FIG. 10 is a flowchart illustrating an example of a processing procedure in the image forming apparatus;

FIG. 11 illustrates an example of a screen displayed on the operation panel; and

FIG. 12A and FIG. 12B illustrate example screens to be displayed on the operation panel.

### DETAILED DESCRIPTION OF THE EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same reference numerals, and redundant description thereof is omitted.

### Preferred Embodiments

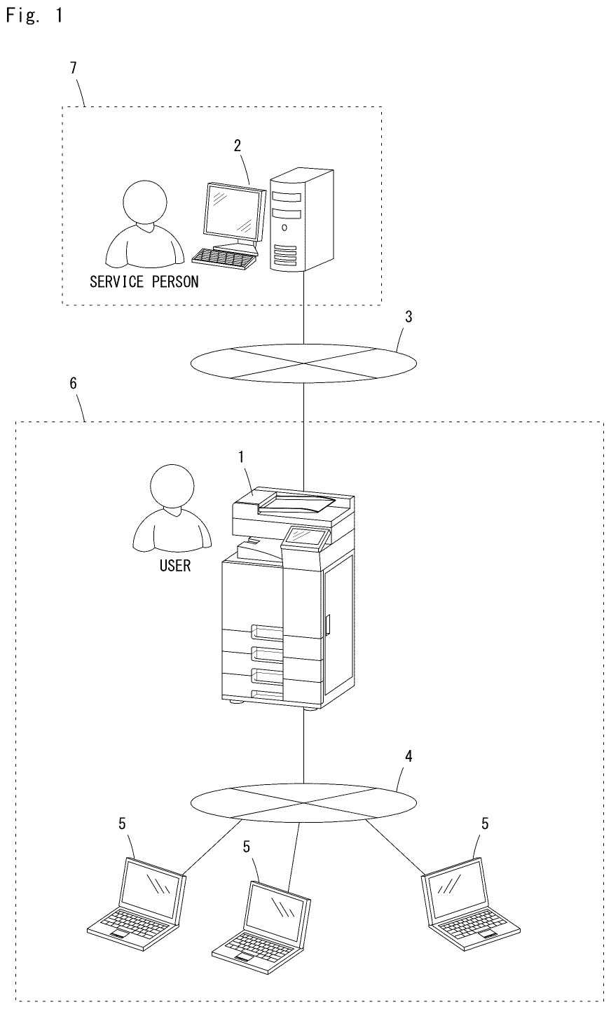

FIG. 1 illustrates an example of the configuration of a network system including an image forming apparatus 1 according to an embodiment of the present invention. The network system is a system in which an image forming apparatus 1 installed in a local environment 6 of a user and an external apparatus 2 installed in a remote service base 7 are communicable with each other via a network 3 such as the Internet.

In the local environment 6, a local network 4 such as a local area network (LAN) is installed. The image forming apparatus 1 and a plurality of information processing apparatuses 5 are connected to the local network 4.

The image forming apparatus 1 is configured by, such as an MFP, and executes various jobs such as a scan job, a print job, and a copy job. For example, in the case of a copy job, the image forming apparatus 1 reads an image of a document set by a user to generate image data, forms an image based on the image data on a sheet such as a printing sheet, and prints out the image.

A user checks the image output from the image forming apparatus 1 to determine whether the job has been normally executed in the image forming apparatus 1. For example, when moire or the like occurs in an image of printed matter output from the image forming apparatus 1, a user determines that an image abnormality has occurred. When the user confirms the image abnormality in the printed matter, the user contacts a service person at the service base 7 and performs work for resolving the image abnormality. For example, the user switches the operation mode of the image forming apparatus 1 from the normal job execution mode to the image abnormality processing mode, reads the image of the printed matter in which the image abnormality has occurred, and transmits the image including the image abnormality to the external apparatus 2 at the service base 7.

The external apparatus 2 is configured by, for example, a personal computer. Upon receiving the image from the image forming apparatus 1, the external apparatus 2 displays the image. A service person at the service base 7 checks the image displayed on the external apparatus 2 and specifies the cause of the occurrence of the image abnormality in the image forming apparatus 1. Based on the specified cause of the occurrence of the image abnormality, the service person guides the user to replace or clean a component, or sends another service person to the local environment 6 for maintenance work.

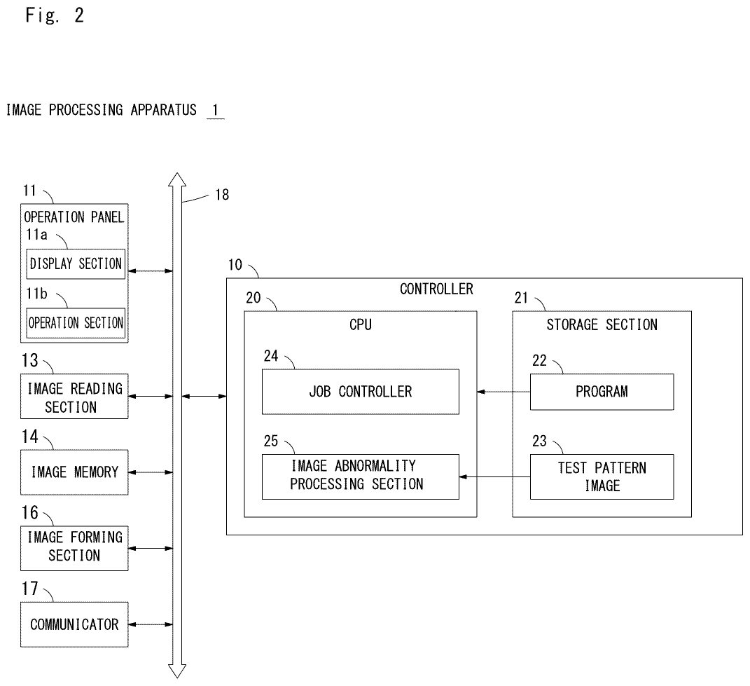

FIG. 2 is a block diagram illustrating an example of a hardware configuration and a functional configuration of the image forming apparatus 1. The image forming apparatus 1 includes, as its hardware configuration, a controller 10, an operation panel 11, an image reading section 13, an image memory 14, an image forming section 16, and a communicator 17. The controller 10, the operation panel 11, the image reading section 13, the image memory 14, the image forming section 16, and the communicator 17 can mutually input and output data via the bus 18.

The controller 10 integrally controls the operation of the image forming apparatus 1. The controller 10 includes a CPU 20 and a storage section 21. The CPU 20 is a hardware processor that reads and executes the program 22 stored in the storage section 21. The storage section 21 is a storage device that stores a program 22 and test pattern images 23. For example, the storage section 21 includes a hard disk drive (HDD) or a solid state drive (SSD).

The operation panel 11 is a user interface used when a user uses the image forming apparatus 1. The operation panel 11 includes a display section 11a that displays various screens that can be operated by the user and an operation section 11b that receives operations by the user. The display section 11a is configured by, for example, a color liquid-crystal display. The operation section 11b includes, for example, touch screen keys arranged on the screen of the display section 11a.

The image reading section 13 operates when a scan job or a copy job is executed in the image forming apparatus 1. The image reading section 13 reads an image of a document set by a user to generate image data.

The image memory 14 is a memory that stores image data generated by execution of a job or image data to be printed. The image memory 14 has a sufficiently large data capacity and can store a plurality of pieces of image data.

The image forming section 16 operates when a print job or a copy job is executed in the image forming apparatus 1. The image forming section 16 forms an image based on the image data to be printed on a sheet fed with the start of the execution of the job, fixes the image on the sheet, and outputs the sheet.

The communicator 17 is a communicator that connects the image forming apparatus 1 to the network 3 and the local network 4 for communication. The image forming apparatus 1 receives a print job transmitted from the information processing apparatus 5 via the communicator 17. The image forming apparatus 1 communicates with the external apparatus 2 via the communicator 17.

The CPU 20 of the controller 10 functions as a job controller 24 and an image abnormality processing section 25 by executing the program 22. The job controller 24 is a controller that operates in the normal job execution mode, and controls operation of each of a scan job, a copy job, and a print job.

The image abnormality processing section 25 operates when an image abnormality occurs as a result of execution of a job in the normal job execution mode and the operation mode is switched to the image abnormality processing mode by a user. The image abnormality processing mode is an operation mode in which an image including an image abnormality is transmitted to the external apparatus 2 at the service base 7.

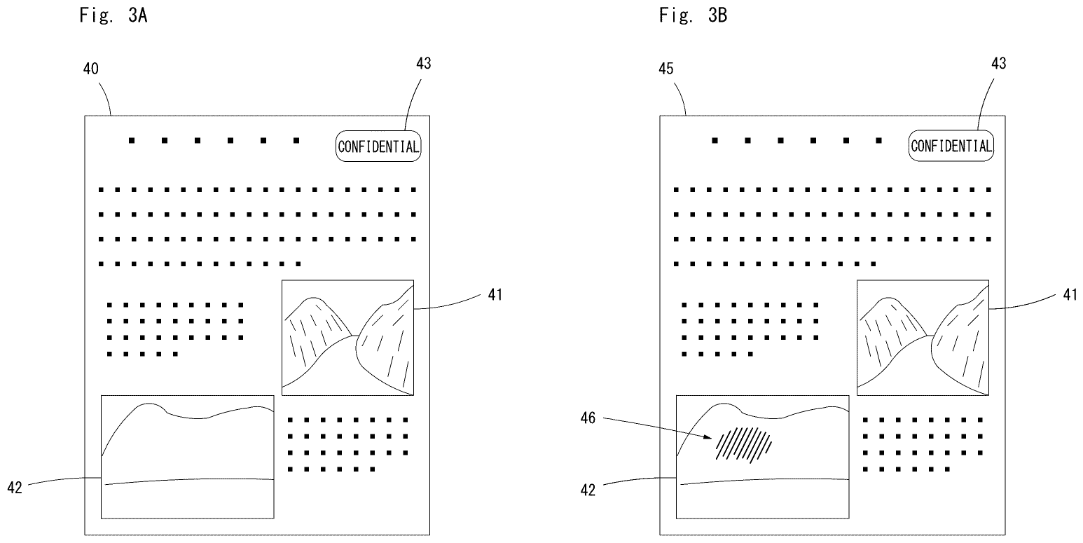

FIGS. 3A and 3B are diagrams illustrating an example in which image abnormality occurs when a copy job is executed in the image forming apparatus 1. FIG. 3A illustrates an image 40 on a sheet serving as a copy source. The image 40 includes a photograph image 41 and a halftone dot image 42. In addition, the image 40 includes a character string in a portion other than the photograph image 41 and the dot image 42. Furthermore, a character string “confidential” is included at an upper right position of the image 40. The character string “confidential” indicates that the image 40 is a confidential document.

FIG. 3B illustrates an image 45 of a sheet on which the image 40 of FIG. 3A is copied and output. As illustrated in FIG. 3B, in the image 45, moire 46 occurs in the dot image 42. The moire 46 is an image that does not exist in the image 40. Therefore, image abnormality occurs in the image 45.

As described above, for example, when an image abnormality such as moire occurs on a sheet (printed matter) output by the image forming apparatus 1 executing a copy job, the user switches the operation mode to the image abnormality processing mode by performing an operation on the operation panel 11. Thus, the image abnormality processing section 25 functions in the controller 10. The image abnormality processing section 25 reads an image of a sheet including an image abnormality such as moire, and transmits image data including the image abnormality to the external apparatus 2. At this time, confidential information may be included in the image of the sheet in which the image abnormality has occurred. In this case, it is not preferable for the image forming apparatus 1 to transmit image data including confidential information to the external apparatus 2.

Therefore, when confidential information is included in an image of a sheet in which an image abnormality has occurred, the image abnormality processing section 25 determines an image area included in the image of the sheet, and generates an image in which each image area is replaced with a test pattern image corresponding to the image area. Next, the image abnormality processing section 25 transmits, to the external apparatus 2, the image data replaced with the test pattern image not including the confidential information. Hereinafter, the image abnormality processing section 25 will be described in detail.

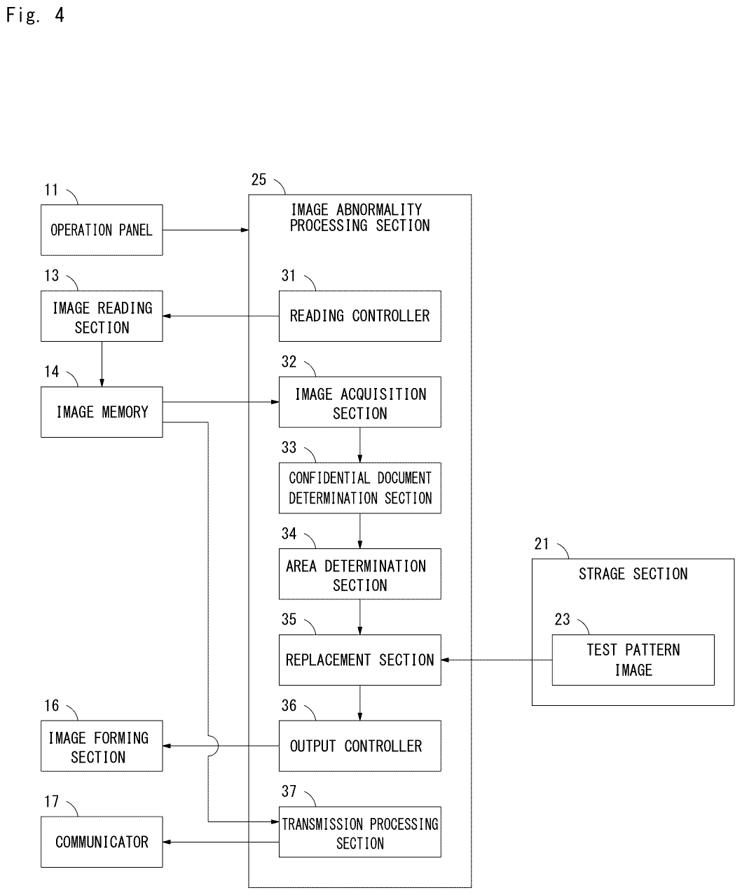

FIG. 4 is a block diagram illustrating a detailed functional configuration of the image abnormality processing section 25. The image abnormality processing section 25 includes a reading controller 31, an image acquisition section 32, a confidential document determination section 33, an area determination section 34, a replacement section 35, an output controller 36, and a transmission processing section 37.

When switched to the image abnormality processing mode by the user, the reading controller 31 displays an image reading guidance screen on the display section 11a of the operation panel 11. The image reading guide screen is a screen for guiding the user to set the sheet in which the image abnormality has occurred in the image reading section 13 and to perform the image reading. The user sets the sheet on which the image abnormality has occurred in the image reading section 13 in accordance with the image reading guide screen, and issues an image reading instruction to the operation panel 11. For example, in a case where the image 45 as illustrated in FIG. 3B is output by the copy job, the user sets the sheet on which the image 45 is formed in the image reading section 13 and performs the image reading instruction.

When detecting an image reading instruction from a user, the reading controller 31 drives the image reading section 13. The image reading section 13 reads an image of a sheet set by a user and stores the image in the image memory 14. Thus, the image including the image abnormality is stored in the image memory 14. For example, an image 45 illustrated in FIG. 3B is stored in the image memory 14.

When the image including the image abnormality is stored in the image memory 14, the image acquisition section 32 reads and acquires the image from the image memory 14. Upon reading an image from the image memory 14, the image acquisition section 32 outputs the image to the confidential document determination section 33.

The confidential document determination section 33 determines whether or not the image stored in the image memory 14 is a confidential document. For example, when the user designates a confidential document on the operation panel 11, the confidential document determination section 33 determines that the image stored in the image memory 14 is a confidential document based on the user's operation.

In addition, the confidential document determination section 33 can automatically determine whether or not a document is a confidential document by analyzing an image stored in the image memory 14. For example, the confidential document determination section 33 determines whether or not the image stored in the image memory 14 includes a predetermined character string such as “confidential”, “confidential”, or “CONFIDENTIAL”. These character strings represent a confidential document. Therefore, when the image stored in the image memory 14 includes a predetermined character string, the confidential document determination section 33 determines that the image is a confidential document. For example, when the image 45 of the 3B of the drawing is stored in the image memory 14, the image 45 includes the character string “confidential”. In this case, the confidential document determination section 33 determines that the image 45 is a confidential document.

When the confidential document determination section 33 determines that the image stored in the image memory 14 is a confidential document, the image abnormality processing section 25 sequentially causes the area determination section 34, the replacement section 35, and the output controller 36 to function.

The area determination section 34 analyzes the image stored in the image memory 14 and determines an image area included in the image. In the present embodiment, the image area determination by the area determination section 34 are three areas of a halftone dot area, a photograph area, and a character area. However, the number of image areas determined by the area discrimination section 34 is not limited to three.

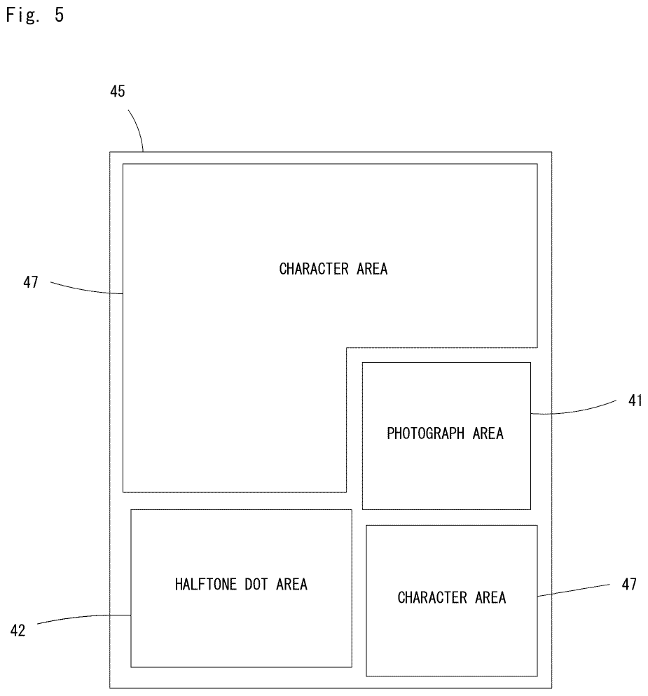

For example, it is assumed that an image 45 illustrated in FIG. 3B is stored in the image memory 14. The area determination section 34 analyzes the image 45 and determines each of a halftone dot area, a photograph area, and a character area included in the image 45. FIG. 5 illustrates a determination result by the area determination section 34. Upon specifying an image area in the image 45, the area determination section 34, as illustrated in FIG. 5, specifies an area including a photograph image 41 as a photograph area. Furthermore, the area determination section 34 determines an area including the dot image 42 as a dot area. Furthermore, the area determination section 34 determines that the area 47 including a character string is a character area. As described above, in a case where the image 45 includes a plurality of image areas that are different from each other, the area determination section 34 determines whether each of multiple image areas is a halftone dot area, a photograph area, or a character area.

When the area determination section 34 determines that the image area included in the image 45 is a halftone dot area, the area determination section 34 specifies the characteristics of the halftone dot area. The characteristic of the halftone dot area is represented by, for example, the number of lines and density of halftone dots. Therefore, the area determination section 34 specifies the number of lines and the density in the dot area of the image 45.

When the area determination section 34 determines that the image area included in the image 45 is a character area, the area determination section 34 specifies the characteristics of the character area. The characteristics of the character area are represented by, for example, line width and density. Therefore, the area determination section 34 specifies the line width and the density in the character area of the image 45.

Further, when the area determination section 34 determines that the image area included in the image 45 is a photograph area, the area determination section 34 specifies the characteristics of the photograph area. The characteristics of the photograph area are represented by, for example, color and density. Therefore, the area determination section 34 specifies the color and the density in the photograph area of the image 45.

The replacement section 35 replaces, for each image area determined by the area determination section 34, an image included in the image area with a test pattern image 23. The storage section 21 stores test pattern images 23 suitable for a halftone dot area, a text area, and a photograph area. The replacement section 35 replaces the halftone dot image 42 included in the image 45 with the test pattern image 23 suitable for a halftone dot area. The replacement section 35 also replaces an image of a character string included in the image 45 with the test pattern image 23 suitable for a character area. Furthermore, the replacement section 35 replaces the photograph image 41 included in the image 45 with the test pattern image 23 suitable for a photograph area.

The storage section 21 stores a plurality of test pattern images 23 corresponding to respective characteristics of a halftone dot area, a character area, and a photograph area. Therefore, when replacing each image of the halftone dot area, the character area, and the photograph area with the test pattern image 23, the replacement section 35 selects one test pattern image 23 from multiple test pattern images 23 based on the characteristics specified by the area determination section 34. The replacement section 35 then replaces the image in the image area with the selected test pattern image 23.

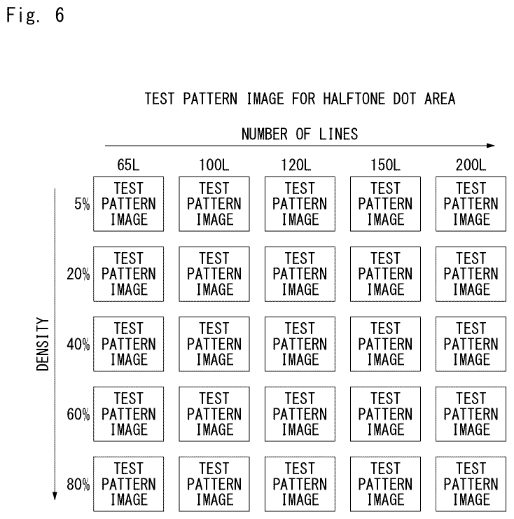

FIG. 6 illustrates a plurality of test pattern images 23 for a dot area. As illustrated in FIG. 6, multiple test pattern images 23 for the halftone dot area are images of halftone dot patterns having different numbers of lines and densities. When replacing the halftone dot area of the image 45 with the test pattern image 23 for the halftone dot area, the replacement section 35 selects the test pattern image 23 having the same or similar characteristics (the number of lines and the density) as the characteristics (the number of lines and the density) of the halftone dot area specified by the area determination section 34, and replaces the halftone dot image 42 included in the halftone dot area of the image 45 with the selected test pattern image 23.

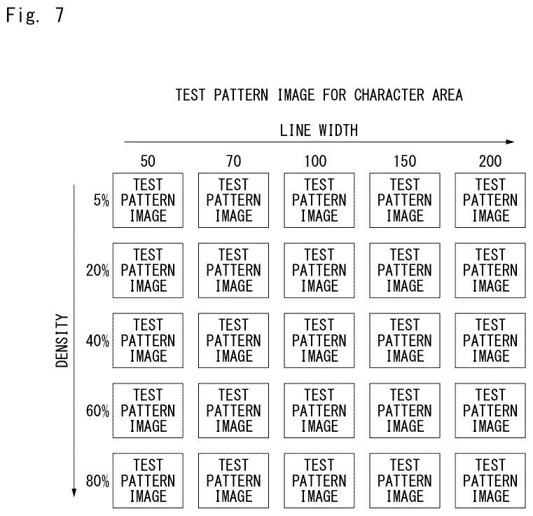

FIG. 7 illustrates a plurality of test pattern images 23 for a character area. As illustrated in FIG. 7, multiple test pattern images 23 for the character area are images of patterns having different line widths and densities. When replacing the character area of the image 45 with the test pattern image 23 for the character area, the replacement section 35 selects the test pattern image 23 having the same or similar characteristics (line width and density) as the characteristics (line width and density) of the character area specified by the area determination section 34, and replaces the image of the character string included in the character area of the image 45 with the selected test pattern image 23.

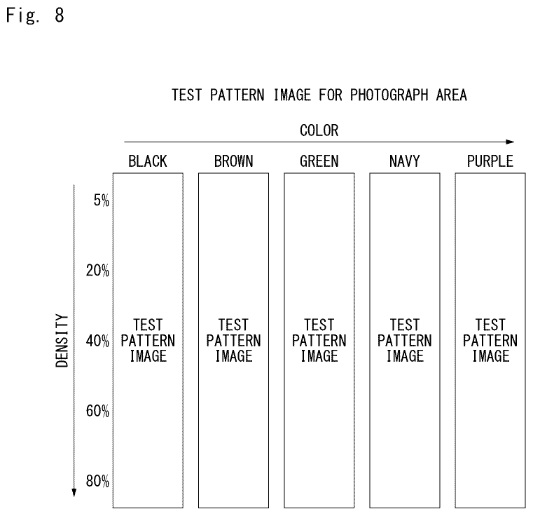

FIG. 8 illustrates a plurality of test pattern images 23 for a photograph area. As illustrates in FIG. 8, multiple test pattern images 23 for the photograph area are images of gradation patterns having different colors and densities. When replacing a photograph area of the image 45 with a test pattern image 23 for a photograph area, the replacement section 35 selects a test pattern image 23 having characteristics (color and density) identical or similar to the characteristics (color and density) of the photograph area specified by the area determination section 34, and replaces the photograph image 41 included in the photograph area of the image 45 with the selected test pattern image 23.

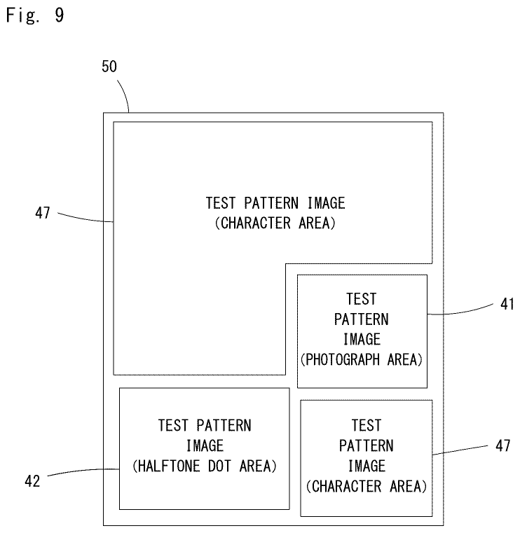

FIG. 9 illustrates an image 50 in which the dot area, the character area, and the photograph area illustrated in FIG. 5 are each replaced with a test pattern image 23. The replacement section 35 replaces the images of the halftone dot area, the character area, and the photograph area with the test pattern images 23 corresponding to the characteristics of the areas to generate the image 50. The halftone dot area, the character area, and the photograph area in the image 50 are located at the same positions as those in the image 45 before the replacement. Therefore, the image 50 has the same layout as the image 45 before being replaced with the test pattern images 23.

Furthermore, none of the multiple test pattern images 23 included in the image 50 includes confidential information. Therefore, image 50 has been converted to an image that does not contain confidential information.

Upon generating the image 50 as described above, the replacement section 35 outputs the image 50 to the output controller 36.

When acquiring the image 50 replaced with the test pattern image 23 from the replacement section 35, the output controller 36 drives the image forming section 16. The image forming section 16 forms the image 50 replaced with the test pattern image 23 on a sheet and outputs the sheet. When the sheet on which the image 50 is formed by the image forming section 16 is output, the reading controller 31 functions again in the image abnormality processing section 25.

When the image 50 replaced with the test pattern image 23 is output, the reading controller 31 displays an image reading guidance screen on the display section 11a of the operation panel 11. The image reading guide screen is a screen for guiding the user to set the sheet on which the image 50 is printed on the image reading section 13 and to perform image reading. The user sets the sheet on which the image 50 is printed in the image reading section 13 in accordance with the image reading guide screen, and issues an image reading instruction to the operation panel 11.

When detecting an image reading instruction from a user, the reading controller 31 drives the image reading section 13, reads an image of a sheet set by the user, and stores the image in the image memory 14. Thus, the image 50 replaced with the test pattern image 23 is stored in the image memory 14.

The image abnormality that has occurred in the image 45 is reproduced in the image 50 stored in the image memory 14. For example, in a case where an image abnormality in the image 45 has occurred in the image forming section 16, the same image abnormality is reproduced when the image forming section 16 forms and outputs the image 50 on a sheet. In a case where the image abnormality in the image 45 has occurred in the image reading section 13, the same image abnormality is reproduced when the image reading section 13 reads the image 50. As a result, the same image abnormality as that occurring in the image 45 occurs in the image 50 stored in the image memory 14.

Subsequently, the image abnormality processing section 25 brings the transmission processing section 37 into operation. The transmission processing section 37 reads the image 50 stored in the image memory 14, and transmits the image 50 to the external apparatus 2 via the communicator 17. Thus, the image forming apparatus 1 can accurately notify the service person at the service base of the state of the image abnormality without transmitting the image of the confidential document including the confidential information to the external apparatus 2.

On the other hand, when the confidential document determination section 33 determines that the image stored in the image memory 14 is not a confidential document, the image abnormality processing section 25 causes the transmission processing section 37 to function without causing the area determination section 34, the replacement section 35, and the output controller 36 to function.

The transmission processing section 37 reads the image stored in the image memory 14 and transmits the image 50 to the external apparatus 2 via the communicator 17. Thus, the image forming apparatus 1 can transmit the image including the image abnormality caused by the execution of the copy job to the external apparatus 2 as it is. At this time, the image transmitted to the external apparatus 2 does not include confidential information. Therefore, the problem of information leakage does not occur.

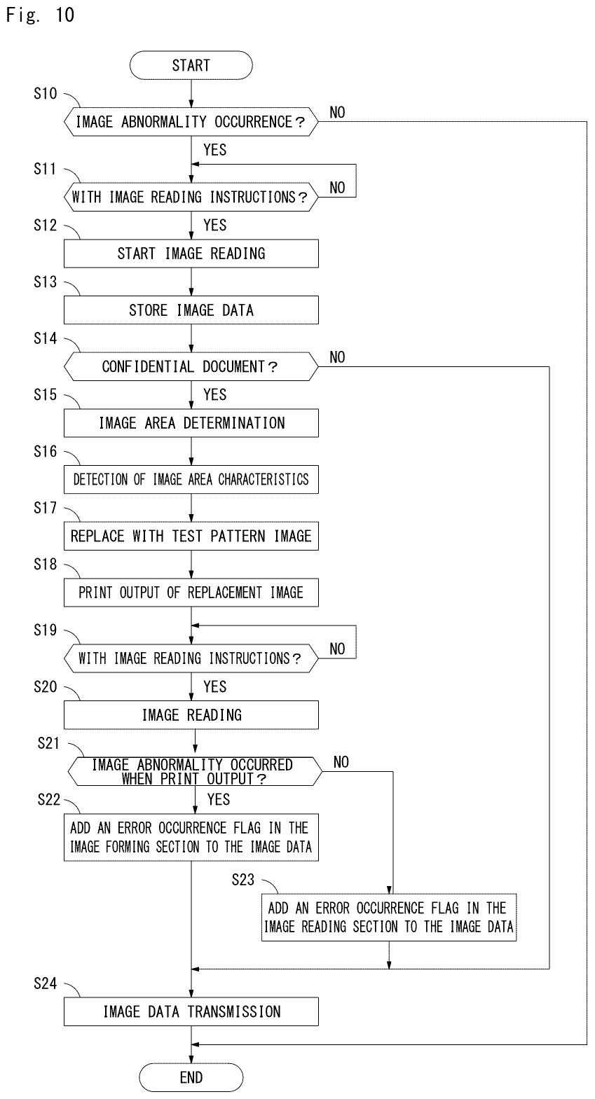

Next, a processing procedure of an image transmission method in the image forming apparatus 1 will be described. FIG. 10 is a flowchart illustrating an example of a processing procedure in the image forming apparatus 1. This processing is performed by the controller 10 when, for example, the CPU 20 of the controller 10 executes the program 22.

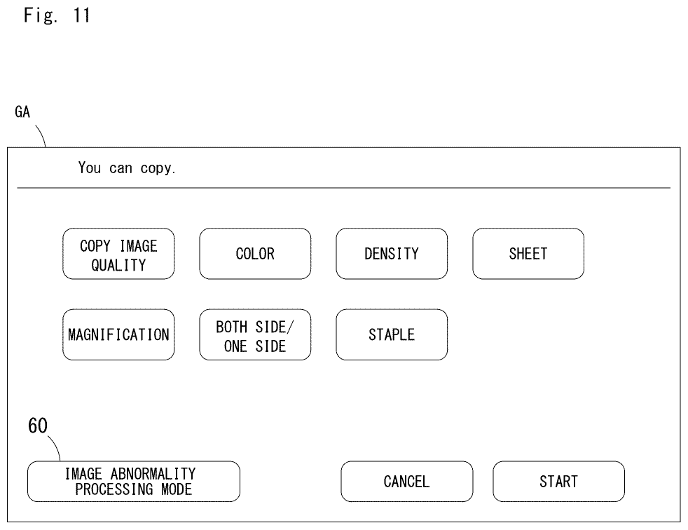

Upon starting the processing, the controller 10 determines whether an image abnormality has occurred (step S10). For example, after executing the job, the controller 10 displays an operation screen GA illustrated in FIG. 11 on the display section 11a of the operation panel 11. On the screen GA, a button 60 to shift the operation mode of the image forming apparatus 1 to an image abnormality processing mode is displayed. For example, after a copy job is executed in the image forming apparatus 1, when an image abnormality is confirmed by a user, the button 60 is operated. When the button 60 is operated by the user, the controller 10 determines that an image abnormality has occurred (step S10). When it is determined that an image abnormality has occurred, the controller 10 causes the image abnormality processing section 25 to function, and switches the operation mode of the image forming apparatus 1 to the image abnormality processing mode. Then, the image abnormality processing section 25 executes the processing in step S11 and subsequent steps.

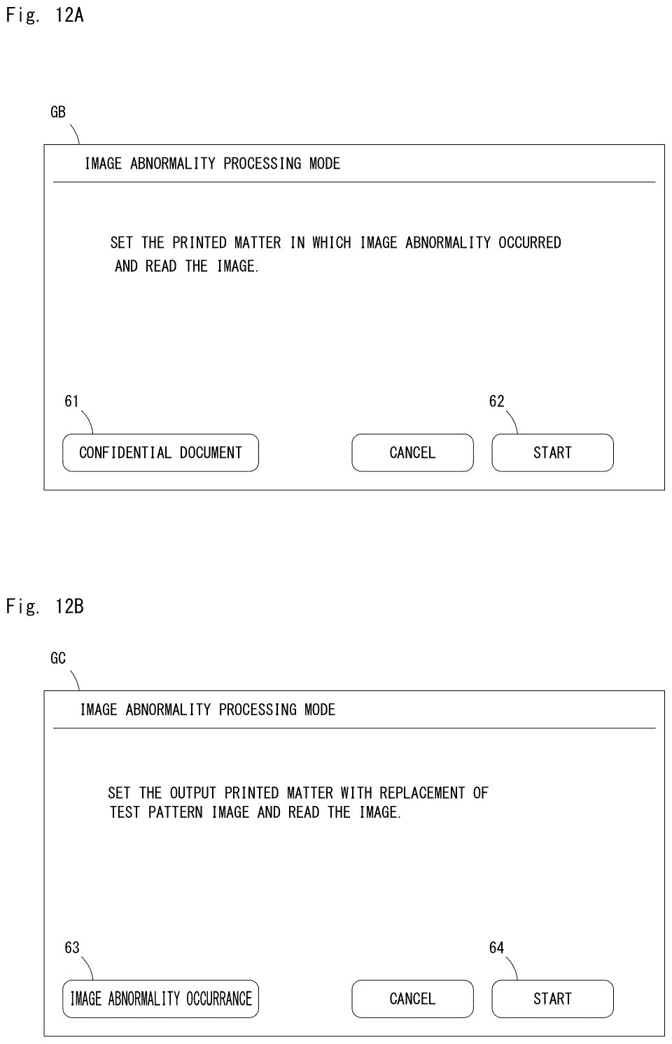

When the mode is switched to the image abnormality processing mode, the image abnormality processing section 25 displays an image reading guide screen GB illustrated in FIG. 12A on the display section 11a of the operation panel 11. On the image reading guide screen GB, a button 61 for the user to specify a confidential document and a button 62 for giving an image reading instruction are displayed. When the image in which the image abnormality has occurred is a confidential document, the user operates the button 61. Furthermore, the user sets, in the image reading section 13, a sheet on which an image including an image abnormality has been formed, and then operates the button 62.

The reading controller 31 waits until an image reading instruction is issued by the user (NO in step S11). When the image reading instruction is performed by the user (YES in step S11), the reading controller 31 drives the image reading section 13 to read the image of the sheet set by the user (step S12). Then, the reading controller 31 stores the image generated by the image reading section 13 in the image memory 14 (step S13).

Next, the image abnormality processing section 25 brings the confidential document determination section 33 into operation. The confidential document determination section 33 determines whether the image stored in the image memory 14 is a confidential document (step S14). For example, the confidential document determination section 33 determines whether or not the document is a confidential document depending on whether or not the button 61 is operated by the user. Alternatively, the confidential document determination section 33 may analyze the image in the image memory 14 and automatically determine whether or not the image is a confidential document based on whether or not the image includes a predetermined character string. Note that when the document is determined not to be a confidential document by the automatic determination, the confidential document determination section 33 preferably displays, on the display section 11a of the operation panel 11, a screen for prompting the user to confirm that the document is not a confidential document.

If the image abnormality processing section 25 determines that the image stored in the image memory 14 is a confidential document (YES in step S14), the image abnormality processing section 25 brings the area determination section 34 into operation. The area determination section 34 determines an image area included in the image stored in the image memory 14 (step S15). When an image stored in an image memory 14 includes a plurality of image areas, an area determination section 34 determinate whether each of multiple image areas is a dot area, a character area or a photograph area.

Next, the area determination section 34 detects the characteristics of the image area included in the image stored in the image memory 14 (step S16). For example, when the image area is a halftone dot area, the area determination section 34 detects the number of lines and the density of halftone dots included in the halftone dot area. When the image area is a character area, the area determination section 34 detects the line width and density of a character included in the character area. Furthermore, when the image area is a photograph area, the area determination section 34 detects the color and density of a photograph image included in the photograph area.

Next, the image abnormality processing section 25 causes the replacement section 35 to function. The replacement section 35 replaces the image in the image area determined by the area determiner 34 with the predetermined test pattern image 23 (step S17). The replacement section 35 selects, for each image area included in the image stored in the image memory 14, a test pattern image 23 that matches the image characteristics of the image area, and replaces the image in the image area with the selected test pattern image 23. That is, the replacement section 35 generates a new image 50 (see FIG. 9) that holds the layout of the image stored in the image memory 14 and the characteristics of each image area. The new image 50 does not include confidential information.

Next, the image abnormality processing section 25 causes the output controller 36 to function. The controller 36 outputs the new image 50 generated by the replacement section 35 to the image forming section 16 to form the image 50 on a sheet (step S18). Thus, the sheet on which the image 50 is printed is output from the image forming section 16. For example, when the image abnormality in the previous image 45 has occurred in the image forming section 16, the same image abnormality as that in the previous image 45 is reproduced in the image 50 of the sheet output in step S18. On the other hand, when the image abnormality in the previous image 45 has occurred in the image reading section 13, the same image abnormality as that in the previous image 45 is not reproduced in the image 50 of the sheet output in step S18. Therefore, the user can determine in which of the image forming section 16 and the image reading section 13 the image abnormality has occurred by checking the image 50 of the sheet output in step S18.

When the sheet on which the image 50 is printed is output, the image abnormality processing section 25 displays an image reading guide screen GC illustrated in FIG. 12B on the display section 11a of the operation panel 11. On the image reading guide screen GC, a button 63 for designating that an image abnormality has occurred in the image 50 of the sheet output in step S18 and a button 64 for issuing an image reading instruction are displayed. If the user determines that an image abnormality has occurred in the image 50 on the sheet output in step S18, the user operates the button 63. Furthermore, the user sets the sheet output in step S18 in the image reading section 13, and then operates the button 64.

The reading controller 31 waits until an image reading instruction is issued by the user (NO in step S19). When the image reading instruction is given by the user (YES in step S19), the reading controller 31 drives the image reading section 13 to read the image 50 of the sheet set by the user (step S20). As a result, the image data corresponding to the image 50 is stored in the image memory 14. For example, when the image abnormality in the previous image 45 has occurred in the image reading section 13, the same image abnormality as that in the previous image 45 is reproduced in the image generated in step S20.

Next, the image abnormality processing section 25 brings the transmission processing section 37 into operation. The transmission processing section 37 determines whether or not an image abnormality has occurred at the time of printout in step S18 (step S21). For example, in a case where the user operates the button 63 when the image reading guide screen GC is displayed, the transmission processing section 37 determines that an image abnormality has occurred at the time of printing out. In contrast, when the user has not operated the button 63, the transmission processing section 37 determines that no image abnormality has occurred at the time of printing out.

When determining that an image abnormality has occurred at the time of printing out (YES in step S21), the transmission processing section 37 adds, to the image date stored in the image memory 14, an abnormality occurrence flag indicating that an image abnormality has occurred in the image forming section 16 (step S22). In contrast, when determining that no image abnormality has occurred at the time of printing out (NO in step S21), the transmission processing section 37 adds, to the image date saved in the image memory 14, an abnormality occurrence flag indicating that an image abnormality has occurred in the image reading section 13 (step S23).

Then, the transmission processing section 37 transmits the image to which the abnormality occurrence flag is added to the external apparatus 2 via the communicator 17 (step S24).

On the other hand, when determining in step S14 that the image saved in the image memory 14 is not a confidential document (NO in step S14), the confidential document determination section 33 brings the transmission processing section 37 into operation. In this case, the transmission processing section 37 reads the image stored in the image memory 14, and transmits the image to the external apparatus 2 via the communicator 17 (step S24).

As described above, the image forming apparatus 1 according to the present embodiment includes the image reading section 13, the area determination section 34, the replacement section 35, and the image forming section 16. The image reading section 13 reads an image formed on a sheet. The area determination section 34 determines an image area included in the image read by the image reading section 13. A replacement section 35 replaces the image of the image area with a test pattern image 23 predetermined according to the image area. The image forming section 16 forms the image replaced with the test pattern image 23 on a sheet and outputs the sheet. When confidential information is included in an image in which an image abnormality has occurred, the image forming apparatus 1 having such a configuration replaces the image in the image area with the test pattern image 23, and thus can generate an image that does not include confidential information. Furthermore, when replacing the image in the image area with the test pattern image 23, the image forming apparatus 1 selects and replaces the test pattern image 23 corresponding to the image area. Therefore, the image forming apparatus 1 can reproduce the image abnormality in the image replaced with the test pattern image 23. Next, the image forming apparatus 1 transmits the image replaced with the test pattern image 23 to the external apparatus 2, thereby preventing leakage of confidential information. Furthermore, a service person at the service base can appropriately specify the cause of the image abnormality by checking the image transmitted from the image forming apparatus 1.

In addition, the image forming apparatus 1 of the present embodiment replaces the image of the image area with the test pattern image 23 for each image area. Therefore, the layout of the image replaced with the test pattern image 23 is the same as the layout of the image in which the image abnormality has occurred. Therefore, even when the image abnormality occurring in the printed matter depends on the document layout, the image forming apparatus 1 can generate an image in which the image abnormality is reproduced. Therefore, the service person at the service base can appropriately specify the cause of the image abnormality by checking the image transmitted from the image forming apparatus 1.

### Modification Example

A preferred embodiment of the present invention has been described above. However, the present invention is not limited to the content described in the above embodiment, and various modification examples are applicable.

For example, the copy job has been described as an example of the job in which the image abnormality occurs in the embodiment described above. However, the job in which the image abnormality occurs is not limited to the copy job. For example, the job in which the image abnormality occurs may be a print job or a scan job. Even if an image abnormality occurs in a print job or a scan job, the image abnormality processing section 25 can perform the above-described processing to prevent leakage of confidential information and generate an image in which the cause of the image abnormality can be specified.

Further, the program 22 described in the above embodiment is not limited to a program stored in advance in the storage section 21 of the image forming apparatus 1. For example, the program 22 may be a transaction target by itself. In this case, the program 22 may be provided in a mode of being downloadable via a network such as the Internet, or may be provided in a state of being recorded in a computer-readable recording medium such as a CD-ROM.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus comprising:
an image reading section that reads an image formed on a sheet;
an area determination section that determines an image area included in the image read by the image reading section;
a replacement section that replaces the image area with a test pattern image predetermined according to the image area; and
an image forming section that forms and outputs an image in which the image area is replaced with the test pattern image.

2. The image forming apparatus according to claim 1, further comprising:
a communicator that communicates with an external apparatus via a network, wherein
the image reading section reads an image output from the image forming section to generate image data; and
the communicator transmits the image data to the external apparatus.

3. The image forming apparatus according to claim 1, further comprising:
an operation section that is operable by a user; and
a controller that causes the area determination section and the replacement section to function and causes the image forming section to output the image replaced with the test pattern image when occurrence of an image abnormality is detected based on a user's operation on the operation section.

4. The image forming apparatus according to claim 1, further comprising:
a confidential document determination section that determines whether or not the image read by the image reading section is a confidential document; and
a controller that, when the confidential document determination section determines that the image is a confidential document, causes the area determination section and the replacement section to function and causes the image forming section to output the image replaced with the test pattern image.

5. The image forming apparatus according to claim 4, wherein
the confidential document determination section determines whether or not the document is a confidential document by analyzing the image read by the image reading section.

6. The image forming apparatus according to claim 5, wherein
the confidential document determination section determines that the document is a confidential document when a predetermined character string is included in the image read by the image reading section.

7. The image forming apparatus according to claim 4, further comprising:
an operation section that is operable by a user, wherein
the confidential document determination section determines whether or not the document is a confidential document based on a user operation on the operation section.

8. The image forming apparatus according to claim 1 wherein
the area determination section determines whether the image area included in the image read by the image reading section is a halftone dot area, a character area, or a photograph area.

9. The image forming apparatus according to claim 8, wherein
the replacing section holds a plurality of test pattern images corresponding to respective characteristics of the halftone dot area, the character area, and the photograph area, and selects one test pattern image from among multiple test pattern images based on the characteristic specified by the area determination section.

10. The image forming apparatus according to claim 9, wherein
the multiple test pattern images hold test pattern images corresponding to respective number of line of the halftone dot area and density, the character line width and density, and the density and color of the photograph area.

11. The image forming apparatus according to claim 2, further comprising:
a transmission processing section, wherein
in a case where an image abnormality occurs in an image output from the image forming section, when transmitting the image data to the external apparatus, the transmission processing section adds information indicating the abnormality in the image forming section to the image data and transmits the image data.

12. The image forming apparatus according to claim 2, further comprising:
a transmission processing section, wherein
in a case where no image abnormality occurs in the image output from the image forming section, when transmitting the image data to the external apparatus, the transmission processing section transmits the image data with information indicating an abnormality in the image reading section added thereto.

13. The image forming apparatus according to claim 11, further comprising:
an operation section that is operable by a user, wherein
the transmission processing section determines, based on a user operation on the operation section, whether or not an image abnormality has occurred in an image output from the image forming section.

14. An image transmission method in an image forming apparatus including an image reading section that reads an image formed on a sheet and an image forming section that forms an image and outputs the image, comprising:
causing the image reading section to read an image of a sheet in which an image abnormality has occurred;
determining an image area included in the image read by the image reading section;
replacing the image area with a test pattern image predetermined according to the image area;
causing the image forming section to form an image in which the image area is replaced with the test pattern image;
causing the image reading section to read an image output from the image forming section to generate image data; and
transmitting the image data to an external apparatus.

15. A non-transitory computer-readable recording medium storing a program to be executed in an image forming apparatus that comprises: an image reading section that reads an image formed on a sheet, and an image forming section that forms and outputs an image; wherein
the program causes the image forming apparatus to execute:
causing the image reading section to read an image of a sheet in which an image abnormality has occurred;
determining an image area included in the image read by the image reading section;
replacing the image area with a test pattern image predetermined in accordance with the image area;
causing the image forming section to form an image in which the image area is replaced with the test pattern image;
causing the image reading section to read an image output from the image forming section to generate image data; and
transmitting the image data to an external apparatus.
